(19) United States
(12) Patent Application Publication
(10) Pub. No.: US 2026/0264398 A1
(43) Pub. Date: Sep. 10, 2026

(54) SYSTEM AND SERVER

(71) Applicant: SEIKO EPSON CORPORATION, Tokyo (JP)

(72) Inventor: Atsushi TOYOFUKU, SHIOJIRI-SHI (JP)

(21) Appl. No.: 19/553,959

(22) Filed: Mar. 2, 2026

(30) Foreign Application Priority Data
Mar. 4, 2025 (JP) 2025-033535

(51) Int. Cl. B41J 2/045; B41J 29/393

(52) U.S. Cl. CPC B41J 2/04588; B41J 2/04581; B41J 29/393

(57) ABSTRACT

A system used to eject ink using an ink jet head includes a storage section that stores correspondence information that defines combinations of characteristic information indicating ejection characteristics of an ink jet head used in accordance with one or more usage conditions, usage condition information indicating the one or more usage conditions, and output condition information indicating an output condition corresponding to the one or more usage conditions, an acquisition section that acquires characteristic information indicating ejection characteristics of an ink jet head used in accordance with a usage condition of a specific user and usage condition information indicating the usage condition of the specific user, and a determination section that determines, with reference to the correspondence information, output condition information indicating an output condition corresponding to the usage condition of the specific user, based on a degree of similarity between the ejection characteristics indicated by the characteristic information acquired by the acquisition section and the ejection characteristics indicated by the characteristic information defined in the correspondence information.

The present application is based on, and claims priority from JP Application Serial Number 2025-033535, filed Mar. 4, 2025, the disclosure of which is hereby incorporated by reference herein in its entirety.

### BACKGROUND

### 1. Technical Field

The present disclosure relates to a system and a server.

### 2. Related Art

In the related art, an ink jet printer including an ink jet head that ejects a liquid such as ink is known. For example, JP-A-2023-60470 discloses a system in which a correspondence relationship between an input value such as ink and a drive waveform is stored in advance in a server, information indicating ink or the like that a user desires to use is transmitted to the server as the input value, and the server responds with information indicating a drive waveform corresponding to the input value.

However, in the above-described related art, when a usage condition of the user, such as a type of ink or a type of the ink jet head, is unknown, it is difficult to output an output condition, such as waveform information, corresponding to the usage condition.

### SUMMARY

According to an aspect of the present disclosure, there is provided a system used to eject ink using an ink jet head, the system including: a storage section that stores correspondence information that defines combinations of characteristic information indicating ejection characteristics of an ink jet head used in accordance with one or more usage conditions, usage condition information indicating the one or more usage conditions, and output condition information indicating an output condition corresponding to the one or more usage conditions; an acquisition section that acquires characteristic information indicating ejection characteristics of an ink jet head used in accordance with a usage condition of a specific user and usage condition information indicating the usage condition of the specific user; and a determination section that determines, with reference to the correspondence information, output condition information indicating an output condition corresponding to the usage condition of the specific user, based on a degree of similarity between the ejection characteristics indicated by the characteristic information acquired by the acquisition section and the ejection characteristics indicated by the characteristic information defined in the correspondence information.

According to another aspect of the present disclosure, there is provided a server for use in a system used to eject ink using an ink jet head, the server including: a storage section that stores correspondence information that defines combinations of characteristic information indicating ejection characteristics of an ink jet head used in accordance with one or more usage conditions, usage condition information indicating the one or more usage conditions, and output condition information indicating an output condition corresponding to the one or more usage conditions; an acquisition section that acquires characteristic information indicating ejection characteristics of an ink jet head used in accordance with a usage condition of a specific user and usage condition information indicating the usage condition of the specific user; and a determination section that determines, with reference to the correspondence information, output condition information indicating an output condition corresponding to the usage condition of the specific user, based on a degree of similarity between the ejection characteristics indicated by the characteristic information acquired by the acquisition section and the ejection characteristics indicated by the characteristic information defined in the correspondence information.

### BRIEF DESCRIPTION OF THE DRAWINGS

FIG. 1 is a schematic diagram illustrating an ink jet printer.

FIG. 2 is a schematic diagram showing a configuration example of a system according to a first embodiment.

FIG. 3 is a diagram showing an example of a configuration of a server.

FIG. 4 is a diagram showing a configuration of an evaluation apparatus.

FIG. 5 is a cross-sectional view showing a configuration example of a head chip.

FIG. 6 is an enlarged cross-sectional view of a vicinity of a piezoelectric element.

FIG. 7 is a block diagram showing an example of a configuration of an ink jet head.

FIG. 8 is a diagram showing a timing chart illustrating an operation of the ink jet head in a recording period.

FIG. 9 is a diagram showing functions of the system.

FIG. 10 is a diagram illustrating contents of correspondence information.

FIG. 11 is a graph illustrating each characteristic value included in characteristic information.

FIG. 12 is a diagram showing a flowchart showing the operations of the system.

FIG. 13 is a diagram showing a flowchart showing an example of a recommended waveform information determination process.

FIG. 14 is a graph illustrating a calculation example of a degree of similarity.

### DESCRIPTION OF EMBODIMENTS

Hereinafter, embodiments for carrying out the present disclosure are described with reference to the drawings. It should be noted that, in each drawing, dimensions and scales of each portion are made different, as appropriate, from actual ones. Additionally, since the embodiments to be described below are preferred specific examples of the present disclosure, various technically preferred limitations are applied; however, unless the following description specifically states that the present disclosure is limited, the scope of the present disclosure is not limited to these embodiments.

### 1. FIRST EMBODIMENT

A system SYS according to a first embodiment provides a service that assists in the use of an ink jet head HU by providing an output condition corresponding to a usage condition of a user U who uses the ink jet head HU when the user U manufactures an ink jet printer 10 that ejects ink using the ink jet head HU. Therefore, in the present specification, first, the ink jet printer 10 will be described, and next, the system SYS will be described.

### 1-1. Overview of Ink Jet Printer 10

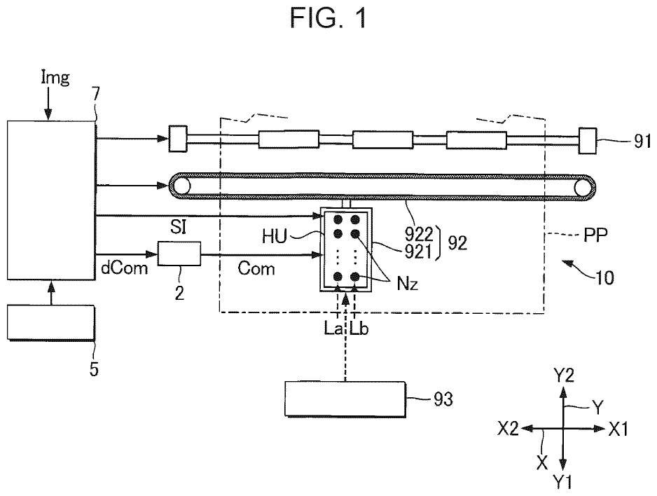

FIG. 1 is a schematic diagram illustrating the ink jet printer 10. The ink jet printer 10 is an ink jet type printing apparatus that ejects ink, which is an example of a liquid, onto a medium PP. The medium PP is typically printing paper; however, any print target such as a resin film or a woven fabric can be utilized as the medium PP.

As illustrated in FIG. 1, the ink jet printer 10 includes a liquid container 93 that stores ink. As the liquid container 93, for example, a cartridge attachable to and detachable from the ink jet printer 10, a bag-shaped ink pack formed of a flexible film, an ink tank into which ink can be replenished, or the like can be employed. A plurality of types of ink differing in color are stored in the liquid container 93.

As illustrated in FIG. 1, the ink jet printer 10 includes a drive signal generation circuit 2, the ink jet head HU, a control circuit 7, a storage circuit 5, a moving mechanism 91, and a transport mechanism 92. The ink jet head HU ejects ink toward the medium PP from 2M nozzles Nz. M is an integer of 1 or greater. In the example of FIG. 1, the 2M nozzles Nz are divided into a nozzle row La and a nozzle row Lb arranged at intervals in a direction along an X-axis.

The control circuit 7 is, for example, a processing circuit such as a CPU or an FPGA. Here, CPU is an abbreviation for “central processing unit”, and FPGA is an abbreviation for “field-programmable gate array”. The control circuit 7 controls each element of the ink jet printer 10.

The storage circuit 5 includes a volatile memory such as RAM and a non-volatile memory such as ROM, EEPROM, or PROM, and stores various kinds of information such as print data Img supplied from a host computer and a control program of the ink jet printer 10. RAM is an abbreviation for “random access memory”. ROM is an abbreviation for “read-only memory”. EEPROM is an abbreviation for “electrically erasable programmable read-only memory”. PROM is an abbreviation for “programmable ROM”.

Under the control of the control circuit 7, the moving mechanism 91 transports the medium PP in a Y1 direction along a Y-axis. Hereinafter, the Y1 direction and a Y2 direction opposite to the Y1 direction are collectively referred to as a direction along the Y-axis. In addition, hereinafter, an X1 direction along the X-axis intersecting the Y-axis and an X2 direction opposite to the X1 direction are collectively referred to as a direction along the X-axis. Further, hereinafter, a Z1 direction along a Z-axis intersecting the X-axis and the Y-axis and a Z2 direction opposite to the Z1 direction are collectively referred to as a direction along the Z-axis. In the present embodiment, as an example, the X-axis, the Y-axis, and the Z-axis are assumed to be orthogonal to each other for description. However, the present disclosure is not limited to such an aspect. The X-axis, the Y-axis, and the Z-axis need only intersect each other.

Under the control of the control circuit 7, the transport mechanism 92 reciprocates the ink jet head HU in the X1 direction and the X2 direction. As shown in FIG. 1, the transport mechanism 92 includes a storage case 921 that houses the ink jet head HU and an endless belt 922 to which the storage case 921 is fixed. The liquid container 93 may be stored in the storage case 921 together with the ink jet head HU.

The control circuit 7 controls an ejection operation of the ink jet head HU. Specifically, the control circuit 7 generates a printing signal SI for controlling the ink jet head HU, a waveform designation signal dCom for controlling the drive signal generation circuit 2, a signal for controlling the transport mechanism 92, and a signal for controlling the moving mechanism 91.

The waveform designation signal dCom is a digital signal for defining a waveform of a drive signal Com. Additionally, the drive signal Com is an analog signal for driving the ink jet head HU. The drive signal generation circuit 2 includes a D/A conversion circuit and generates the drive signal Com having the waveform defined by the waveform designation signal dCom.

In addition, the printing signal SI is a digital signal for designating a type of operation of the ink jet head HU. Specifically, the printing signal SI is a signal for designating whether or not to eject ink from each of one or more nozzles Nz by designating whether or not to supply the drive signal Com to the ink jet head HU.

The control circuit 7 first stores the print data Img supplied from the host computer in the storage circuit 5. Next, the control circuit 7 generates various control signals such as the printing signal SI, the waveform designation signal dCom, the signal for controlling the transport mechanism 92, and the signal for controlling the moving mechanism 91, based on various pieces of data such as the print data Img stored in the storage circuit 5. Then, the control circuit 7 controls the ink jet head HU based on the various control signals and the various pieces of data stored in the storage circuit 5, while controlling the transport mechanism 92 and the moving mechanism 91 to change a relative position of the medium PP with respect to the ink jet head HU. As a result, the control circuit 7 controls execution of image processing of forming, on the medium PP, an image corresponding to the print data Img.

### 1-2. Overview of System SYS

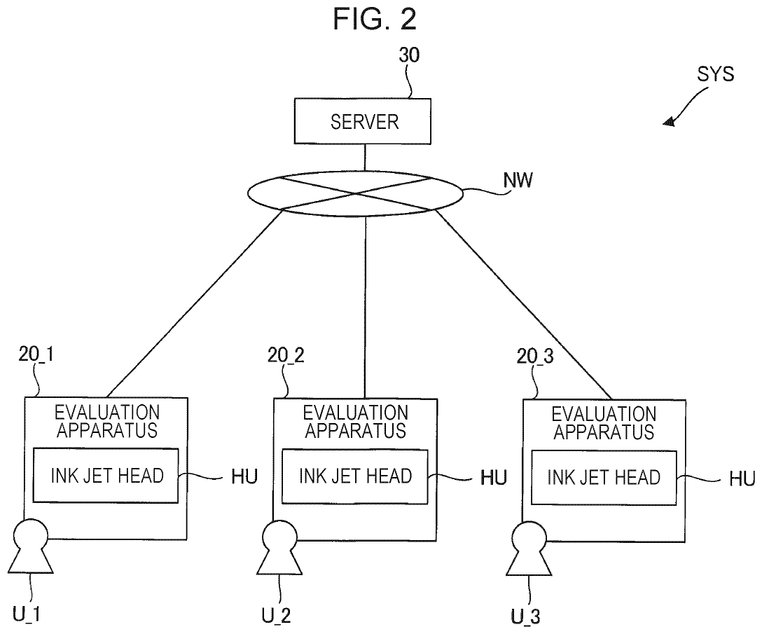

FIG. 2 is a schematic diagram showing a configuration example of the system SYS according to the first embodiment. As described above, the system SYS provides a service that provides an output condition corresponding to the usage condition of the user U. The system SYS includes evaluation apparatuses 20_1 to 20_3 and a server 30. Instead of the evaluation apparatuses 20_1 to 20_3 of the users, a processing apparatus (a PC, a smartphone, or the like) of the user may be connected to the server 30.

The evaluation apparatuses 20_1 to 20_3 are apparatuses that evaluate the ink jet head HU. In the following description, each of the evaluation apparatuses 20_1 to 20_3 may be collectively referred to, without distinction, as an evaluation apparatus 20. For example, as a function of evaluating the ink jet head HU, the evaluation apparatuses 20_1 to 20_3 have, for example, a function of observing an ejection state of ink droplets ejected from the ink jet head HU and a function of observing how ink droplets land on the medium PP.

The user U who uses the evaluation apparatus 20 is a vendor that manufactures the ink jet printer 10. Hereinafter, the user U who uses the evaluation apparatus 20 may be referred to as a “printer manufacturer”. Meanwhile, a vendor that manufactures the ink jet head HU and the evaluation apparatus 20 may be referred to as a “head manufacturer”. The printer manufacturer acquires the evaluation apparatus 20 from the head manufacturer and evaluates the ink jet head HU using the evaluation apparatus 20 such that an image formed on the medium PP by the ink jet printer 10 satisfies conditions desired by the printer manufacturer.

In the example of FIG. 2, one evaluation apparatus 20 includes one ink jet head HU. However, the number of ink jet heads HU that one evaluation apparatus 20 includes is not limited to one, and one evaluation apparatus 20 may include two or more ink jet heads HU.

FIG. 2 shows a user U_1 who uses the evaluation apparatus 20_1, a user U_2 who uses the evaluation apparatus 20_2, and a user U_3 who uses the evaluation apparatus 20_3. In the following description, the users U_1 to U_3 may be collectively referred to, without distinction, as a user U.

In the example shown in FIG. 2, the system SYS includes three evaluation apparatuses 20; however, the number of evaluation apparatuses 20 that the system SYS includes is not limited to three and may be one, two, or four or more.

The server 30 is a computer that functions as a cloud server CS, which will be described below. The head manufacturer utilizes a part of the server 30. The evaluation apparatus 20 is communicably connected to the server 30 via a network NW such as a LAN, a WAN, and the Internet. LAN is an abbreviation for “local area network”. WAN is an abbreviation for “wide area network”.

### 1-3. Configuration of Server 30

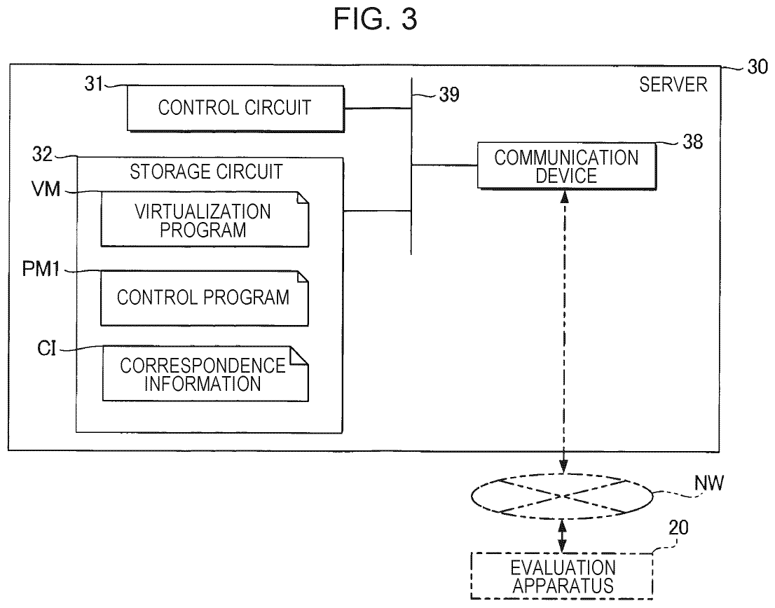

FIG. 3 is a diagram showing an example of a configuration of the server 30. The server 30 includes a control circuit 31, a storage circuit 32, and a communication device 38. The control circuit 31, the storage circuit 32, and the communication device 38 are mutually connected via a bus 39 for information communication.

The control circuit 31 includes, for example, one or more processors such as a CPU. CPU is an abbreviation for “central processing unit”. The control circuit 31 may include, in place of or in addition to the CPU, a programmable logic device such as an FPGA. FPGA is an abbreviation for “field-programmable gate array”.

The storage circuit 32 is configured with a magnetic storage device, a flash ROM, or the like. The storage circuit 32 is readable by the control circuit 31 and stores a plurality of programs including a virtualization program VM and a control program PM1 executed by the control circuit 31, correspondence information CI, various kinds of information used by the control circuit 31, and the like. The virtualization program VM divides resources such as the control circuit 31 and the storage circuit 32 of the server 30 into a plurality of parts and causes each divided resource to operate as the cloud server CS. The head manufacturer utilizes, as a part of the server 30, some of a plurality of cloud servers CS. The control program PM1 is developed by the head manufacturer. The control program PM1 and the correspondence information CI are used to implement the service provided by the system SYS. The storage circuit 32 is an example of a “storage section”.

However, the storage circuit 32 need not include the virtualization program VM, and the evaluation apparatus 20 may access the server 30 instead of the cloud server CS.

The storage circuit 32 includes, for example, semiconductor memories of one or both of one or more volatile memories, such as RAM, and one or more non-volatile memories, such as ROM, EEPROM, or PROM. RAM is an abbreviation for “random access memory”. ROM is an abbreviation for “read-only memory”. EEPROM is an abbreviation for “electrically erasable programmable read-only memory”. PROM is an abbreviation for “programmable ROM”.

The communication device 38 is hardware including a communication circuit for communicating with the evaluation apparatus 20 via the network NW. The communication device 38 is also referred to, for example, as a network device, a network controller, a network card, or a communication module.

### 1-4. Configuration of Evaluation Apparatus 20

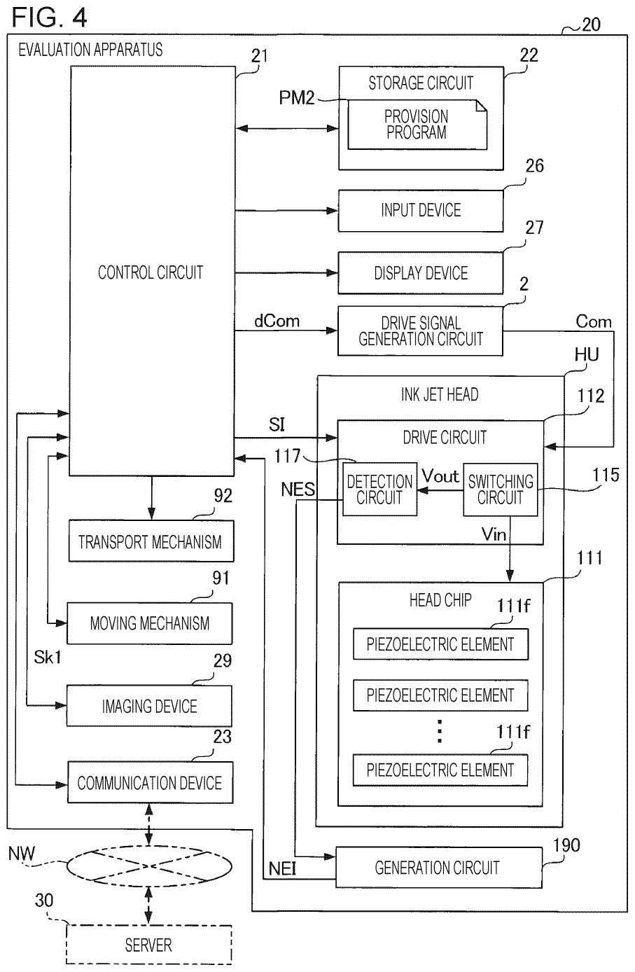

FIG. 4 is a diagram showing a configuration of the evaluation apparatus 20. The evaluation apparatus 20 includes a control circuit 21, a storage circuit 22, a communication device 23, an input device 26, a display device 27, the moving mechanism 91, the transport mechanism 92, the drive signal generation circuit 2, the ink jet head HU, an imaging device 29, and a generation circuit 190.

The control circuit 21 includes, for example, one or more processors such as a CPU. The control circuit 21 may include, in place of or in addition to the CPU, a programmable logic device such as an FPGA.

The storage circuit 22 is configured with a magnetic storage device, a flash ROM, or the like. The storage circuit 22 is readable by the control circuit 21 and stores a plurality of programs including a provision program PM2 executed by the control circuit 21, various kinds of information used by the control circuit 21, and the like. The storage circuit 22 includes, for example, semiconductor memories of one or both of one or more volatile memories, such as RAM, and one or more non-volatile memories, such as ROM, EEPROM, or PROM. The provision program PM2 may be preinstalled in, for example, the evaluation apparatus 20, or, when the evaluation apparatus 20 is initially connected to the server 30, may be downloaded from the cloud server CS operating on the server 30 and installed in the evaluation apparatus 20.

The communication device 23 is hardware including a communication circuit for communicating with the server 30 via the network NW. The communication device 23 is also referred to, for example, as a network device, a network controller, a network card, or a communication module.

The input device 26 is a device that outputs operation information corresponding to an operation of the user U. The input device 26 is, for example, a mouse and a keyboard.

The display device 27 displays an image indicating some kind of information to the user U. The display device 27 is an organic EL display, an LED display, and an LCD. EL is an abbreviation for “electro-luminescence”. LED is an abbreviation for “light-emitting diode”. LCD is an abbreviation for “liquid crystal display”. Additionally, the input device 26 and the display device 27 may be configured integrally. A configuration in which the input device 26 and the display device 27 are formed integrally is, for example, a touch panel.

Since the moving mechanism 91, the transport mechanism 92, the drive signal generation circuit 2, and the ink jet head HU provided in the evaluation apparatus 20 have the same functions as the moving mechanism 91, the transport mechanism 92, the drive signal generation circuit 2, and the ink jet head HU provided in the ink jet printer 10 shown in FIG. 1, the description thereof will not be repeated.

The imaging device 29 images ink droplets ejected from the ink jet head HU. Specifically, the imaging device 29 includes, for example, an imaging optical system and an imaging element. The imaging optical system is an optical system including at least one imaging lens and may include various optical elements such as a prism, or may include a zoom lens, a focus lens, or the like. The imaging element is, for example, a CCD image sensor, a CMOS image sensor, or the like. CCD is an abbreviation for “charge-coupled device”. CMOS is an abbreviation for “complementary MOS”.

In order to implement a part of the functions of the evaluation apparatus 20 described above, namely a function of observing the ejection state of ink droplets ejected from the ink jet head HU and a function of observing how ink droplets land on the medium PP, the control circuit 21 transmits an imaging instruction Sk1 to the imaging device 29, transmits the printing signal SI to the ink jet head HU, and transmits the waveform designation signal dCom to the drive signal generation circuit 2. The imaging device 29 transmits to the control circuit 21 image information indicating an image in which one or both of ink droplets in flight and ink droplets landed on the medium PP are captured.

The ink jet head HU is an assembly including a head chip 111 and a drive circuit 112.

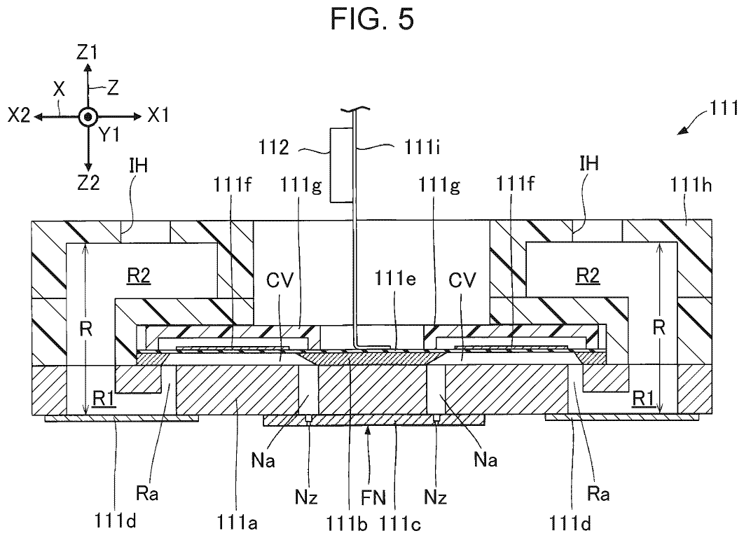

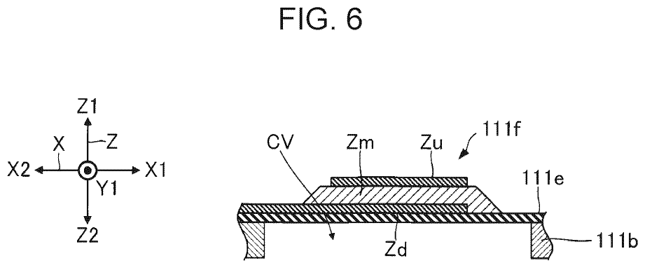

The head chip 111 ejects ink toward the medium PP. In FIGS. 4, 2M piezoelectric elements 111f, among components of the head chip 111, are representatively shown. One example of details of the head chip 111 will be described below with reference to FIGS. 5 and 6.

In the example shown in FIG. 4, the number of head chips 111 provided in the ink jet head HU is one; however, the number may be two or more. One or more head chips 111 are disposed such that a plurality of nozzles Nz are distributed over a part of a width direction of the medium PP.

Under the control of the control circuit 21, the drive circuit 112 switches, for each of a plurality of piezoelectric elements 111f provided in the head chip 111, whether or not to supply the drive signal Com output from the drive signal generation circuit 2.

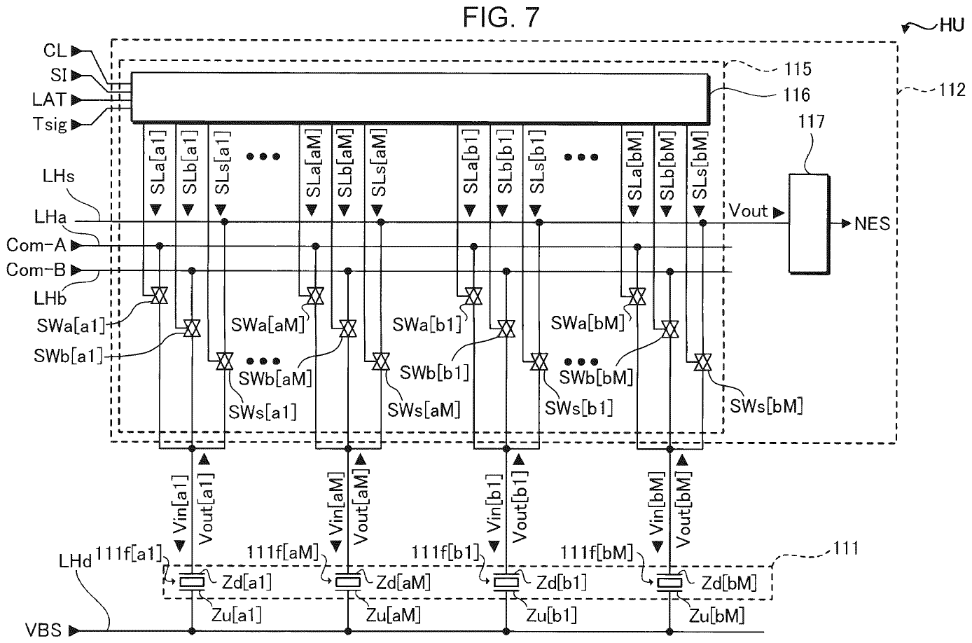

The drive circuit 112 includes a switching circuit 115 and a detection circuit 117. Under the control of the control circuit 21, the switching circuit 115 switches, for each of the 2M piezoelectric elements 111 f provided in the head chip 111 coupled to the drive circuit 112, whether or not to supply the drive signal Com output from the drive signal generation circuit 2. In addition, the switching circuit 115 switches whether or not to electrically couple each piezoelectric element 111f to the detection circuit 117. In the present embodiment, it is assumed that the drive signal Com includes a drive signal Com-A and a drive signal Com-B. Additionally, among the drive signals Com-A and Com-B, a signal that is actually supplied to the piezoelectric element 111f may be referred to as a supply drive signal Vin. The switching circuit 115 includes, for example, a group of switches, such as transmission gates for the switching. Details of the switching circuit 115 will be described below with reference to FIG. 7. The detection circuit 117, after the piezoelectric element 111f is driven, outputs to the generation circuit 190 a residual vibration signal NES indicating vibration remaining in a pressure chamber CV, which will be described below. More specifically, the detection circuit 117 generates the residual vibration signal NES, based on a detection signal Vout detected from the piezoelectric element 111f driven by the drive signal Com.

FIG. 5 is a cross-sectional view showing a configuration example of the head chip 111. However, in FIG. 5, the drive circuit 112 is also shown in addition to the head chip 111. The head chip 111 is configured to be substantially symmetrical in the direction along the X-axis. However, positions in the direction along the Y-axis of the nozzles Nz divided into the nozzle row La and the plurality of nozzles Nz of the nozzle row Lb may coincide with each other or may differ from each other. In FIG. 5, a configuration is illustrated in which the positions in the direction along the Y-axis of the plurality of nozzles Nz of the nozzle row La and the plurality of nozzles Nz of the nozzle row Lb coincide with each other.

As shown in FIG. 5, the head chip 111 includes a flow path substrate 111a, a pressure chamber substrate 111b, a nozzle plate 111c, a vibration absorbing member 111d, a diaphragm 111e, the plurality of piezoelectric elements 111f, a protective plate 111g, a case 111h, and a wiring substrate 111i.

The flow path substrate 111a and the pressure chamber substrate 111b are stacked in this order in the Z1 direction and form flow paths for supplying ink to the plurality of nozzles Nz. In a region located in the Z1 direction with respect to a laminate formed of the flow path substrate 111a and the pressure chamber substrate 111b, the diaphragm 111e, the plurality of piezoelectric elements 111f, the protective plate 111g, the case 111h, and the wiring substrate 111i are installed. On the other hand, in a region located in the Z2 direction with respect to the laminate, the nozzle plate 111c and the vibration absorbing member 111d are installed. Respective elements of the head chip 111 are, in outline, plate-like members elongated in the Y direction and are joined to each other, for example, with an adhesive. Hereinafter, the respective elements of the head chip 111 will be described in order.

The nozzle plate 111c is a plate-like member in which, for each of the nozzle row La and the nozzle row Lb, the plurality of nozzles Nz are provided. Each of the plurality of nozzles Nz is a through-hole that allows ink to pass. Here, a surface of the nozzle plate 111c that faces in the Z2 direction is a nozzle surface FN. The nozzle plate 111c is manufactured, for example, by processing a single-crystal silicon substrate by a semiconductor manufacturing technique using a processing technique such as dry etching or wet etching. However, other known methods and materials may be used as appropriate to manufacture the nozzle plate 111c. Additionally, a cross-sectional shape of the nozzle Nz is typically circular; however, the present disclosure is not limited to this shape, and, for example, a noncircular shape such as a polygonal shape or an elliptical shape may be used.

In the flow path substrate 111a, for each of the nozzle row La and the nozzle row Lb, a space R1, a plurality of supply flow paths Ra, and a plurality of communication flow paths Na are provided. The space R1 is an elongated opening extending in the direction along the Y-axis in plan view as seen in the direction along the Z-axis. Each of the supply flow path Ra and the communication flow path Na is a through-hole formed for each nozzle Nz. Each supply flow path Ra communicates with the space R1.

The pressure chamber substrate 111b is a plate-like member in which, for each of the nozzle row La and the nozzle row Lb, a plurality of pressure chambers CV, referred to as cavities, are provided. The plurality of pressure chambers CV are arranged in the direction along the Y-axis. Each pressure chamber CV is formed for each nozzle Nz and is an elongated space extending in the direction along the X-axis in plan view. The flow path substrate 111a and the pressure chamber substrate 111b are each manufactured, similarly to the nozzle plate 111c described above, for example, by processing a single-crystal silicon substrate by a semiconductor manufacturing technique. However, other known methods and materials may be used as appropriate to manufacture each of the flow path substrate 111a and the pressure chamber substrate 111b.

The pressure chamber CV is a space located between the flow path substrate 111a and the diaphragm 111e. For each of the nozzle row La and the nozzle row Lb, the plurality of pressure chambers CV are arranged in the direction along the Y-axis. Additionally, the pressure chamber CV communicates with each of the communication flow path Na and the supply flow path Ra. Accordingly, the pressure chamber CV communicates with the nozzle Nz via the communication flow path Na and communicates with the space R1 via the supply flow path Ra.

On a surface of the pressure chamber substrate 111b that faces the Z1 direction, the diaphragm 111e is disposed. The diaphragm 111e is a plate-like member that is elastically vibratable. The diaphragm 111e includes, for example, a first layer and a second layer, which are stacked in this order in the Z1 direction. The first layer is, for example, an elastic film made of silicon oxide (SiO₂). The elastic film is formed, for example, by thermally oxidizing one surface of a single-crystal silicon substrate. The second layer is, for example, an insulating film made of zirconium oxide (ZrO₂). The insulating film is formed, for example, by forming a layer of zirconium by a sputtering method and thermally oxidizing the layer. The diaphragm 111e is not limited to the configuration of stacking the first layer and the second layer described above and may be formed of, for example, a single layer or of three or more layers.

On the surface of the diaphragm 111e that faces the Z1 direction, for each of the nozzle row La and the nozzle row Lb, the plurality of piezoelectric elements 111f respectively corresponding to the nozzles Nz are disposed. Each piezoelectric element 111f is a passive element that deforms upon supply of the drive signal Com. Each piezoelectric element 111f has an elongated shape extending in the direction along the X-axis in plan view. The plurality of piezoelectric elements 111f are arranged in the direction along the Y-axis so as to correspond to the plurality of pressure chambers CV. Each piezoelectric element 111f overlaps, in plan view, the pressure chamber CV.

FIG. 6 is an enlarged cross-sectional view of the vicinity of the piezoelectric element 111f. However, in FIG. 6, in order to prevent the drawing from being complicated, the protective plate 111g is not shown.

As illustrated in FIG. 6, the piezoelectric element 111f is a laminate in which a piezoelectric body Zm is interposed between an upper electrode Zu to which an offset potential VBS is supplied and a lower electrode Zd to which the drive signal Com is supplied. The piezoelectric element 111f is, for example, a portion in which the lower electrode Zd, the upper electrode Zu, and the piezoelectric body Zm overlap, as seen from the Z1 direction. Additionally, in the Z2 direction with respect to the piezoelectric element 111f, the pressure chamber CV is provided. Note that, in the first embodiment, an aspect is employed in which the offset potential VBS is supplied to the upper electrode Zu and the drive signal Com is supplied to the lower electrode Zd; however, an aspect may be employed in which the drive signal Com is supplied to the upper electrode Zu and the offset potential VBS is supplied to the lower electrode Zd.

In the first embodiment, the lower electrode Zd is an individual electrode disposed apart for each piezoelectric element 111f. On the other hand, the upper electrode Zu is a band-like common electrode extending in the direction along the Y-axis so as to be continuous over the plurality of piezoelectric elements 111f. As metal materials for the lower electrode Zd and the upper electrode Zu, examples include metal materials such as platinum (Pt), aluminum (Al), nickel (Ni), gold (Au), and copper (Cu), and one kind alone or two or more kinds can be used in combination in the form of an alloy, a laminate, or the like.

The piezoelectric body Zm is made of a piezoelectric material such as lead zirconate titanate (Pb(Zr, Ti)O₃) and has, for example, a band-like shape extending in the direction along the Y-axis so as to be continuous over the plurality of piezoelectric elements 111f. However, the piezoelectric body Zm may be formed integrally over the plurality of piezoelectric elements 111f. In this case, in the piezoelectric body Zm, in regions that correspond, in plan view, to gaps between adjacent pressure chambers CV, through-holes that penetrate the piezoelectric body layer are provided to extend in the direction along the X-axis. When the diaphragm 111e vibrates in conjunction with the above deformation of the piezoelectric element 111f, pressure inside the pressure chamber CV fluctuates, whereby ink is ejected from the nozzle Nz.

The description returns to FIG. 5. The protective plate 111g is a plate-like member installed on the surface of the diaphragm 111e that faces the Z1 direction, and protects the plurality of piezoelectric elements 111f and reinforces mechanical strength of the diaphragm 111e. Here, the plurality of piezoelectric elements 111f are housed between the protective plate 111g and the diaphragm 111e. The protective plate 111g is made of, for example, a resin material.

The case 111h is a member for storing ink supplied to the plurality of pressure chambers CV. The case 111h is made of, for example, a resin material. For each of the nozzle row La and the nozzle row Lb, a space R2 is provided in the case 111h. The space R2 is a space that communicates with the space R1 described above and, together with the space R1, functions as a reservoir R that stores ink supplied to the plurality of pressure chambers CV. The case 111h is provided with an inlet port IH for supplying ink to each reservoir R. Ink in each reservoir R is supplied to the pressure chamber CV via each supply flow path Ra.

The vibration absorbing member 111d, which is also referred to as a compliance substrate, is a flexible resin film that constitutes a wall surface of the reservoir R and absorbs pressure fluctuations of ink inside the reservoir R. The vibration absorbing member 111d may be a thin plate made of metal and having flexibility. A surface of the vibration absorbing member 111d that faces the Z1 direction is joined to the flow path substrate 111a with an adhesive or the like.

The wiring substrate 111i is mounted on the surface of the diaphragm 111e that faces the Z1 direction, and is a mounting component for electrically coupling the head chip 111 to the drive circuit 112. The wiring substrate 111i is, for example, a flexible wiring substrate such as a COF, an FPC, or an FFC. In the wiring substrate 111i of the present embodiment, the above-described drive circuit 112 is mounted. COF is an abbreviation for “chip on film”. FPC is an abbreviation for “flexible printed circuit”. FFC is an abbreviation for “flexible flat cable”.

Hereinafter, when n1 is a or b and m1 is any integer from 1 to M, elements related to a nozzle Nz[n1m1] may be referred to by appending [n1m1]. For example, a pressure chamber CV that communicates with the nozzle Nz[n1m1] may be referred to as a pressure chamber CV[n1m1], and a piezoelectric element 111f that applies pressure to the pressure chamber CV[n1m1] may be referred to as a piezoelectric element 111f[n1m1]. Similarly, elements related to a determination target nozzle Nz-H may be referred to by appending “-H”. For example, a pressure chamber CV that communicates with the determination target nozzle Nz-H may be referred to as a “determination target pressure chamber CV-H”, and a piezoelectric element 111f that applies pressure to the determination target pressure chamber CV-H may be referred to as a “determination target piezoelectric element 111f-H”.

### 1-5. Configuration of Ink Jet Head HU

Hereinafter, the configuration of the ink jet head HU will be described with reference to FIG. 7.

FIG. 7 is a block diagram showing an example of a configuration of the ink jet head HU. FIG. 7 shows the head chip 111 and the drive circuit 112 provided in the ink jet head HU.

The ink jet head HU includes, in addition to the head chip 111 and the drive circuit 112, internal wiring LHa to which the drive signal Com-A is supplied from the drive signal generation circuit 2, internal wiring LHb to which the drive signal Com-B is supplied from the drive signal generation circuit 2, internal wiring LHs for supplying to the detection circuit 117 the detection signal Vout detected from the piezoelectric element 111f, and internal wiring LHd to which the offset potential VBS is supplied.

As shown in FIG. 7, the switching circuit 115 includes 2M switches SWa[a1] to SWa[bM], 2M switches SWb[a1] to SWb[bM], 2M switches SWs[a1] to SWs[bM], and a coupling state designation circuit 116 that designates a coupling state of each switch. For example, a transmission gate can be employed as each switch.

The coupling state designation circuit 116 generates, based on at least a part of signals supplied from the control circuit 21, namely the printing signal SI, a latch signal LAT, and a period designation signal Tsig, coupling state designation signals SLa[a1] to SLa[bM] that designate on/off of the switches SWa[a1] to SWa[bM], coupling state designation signals SLb[a1] to SLb[bM] that designate on/off of the switches SWb[a1] to SWb[bM], and coupling state designation signals SLs[a1] to SLs[bM] that designate on/off of the switches SWs[a1] to SWs[bM].

When n1 is a or b and m1 is any integer from 1 to M, a switch SWa[n1m1] switches, in accordance with a coupling state designation signal SLa[n1m1], conduction and non-conduction between the internal wiring LHa and the lower electrode Zd[n1m1] of the piezoelectric element 111f[n1m1]. For example, the switch SWa[n1m1] turns on when the coupling state designation signal SLa[n1m1] is at a high level, and turns off when the coupling state designation signal SLa[n1m1] is at a low level.

When n1 is a or b and m1 is any integer from 1 to M, a switch SWb[n1m1] switches, in accordance with a coupling state designation signal SLb[n1m1], conduction and non-conduction between the internal wiring LHb and the lower electrode Zd[n1m1] of the piezoelectric element 111f[n1m1]. For example, the switch SWb[n1m1] turns on when the coupling state designation signal SLb[n1m1] is at a high level, and turns off when the coupling state designation signal SLb[n1m1] is at a low level.

When n1 is a or b and m1 is any integer from 1 to M, a switch SWs[n1m1] switches, in accordance with a coupling state designation signal SLs[n1m1], conduction and non-conduction between the internal wiring LHs and the lower electrode Zd[n1m1] of the piezoelectric element 111f[n1m1]. For example, the switch SWs[n1m1] turns on when the coupling state designation signal SLs[n1m1] is at a high level, and turns off when the coupling state designation signal SLs[n1m1] is at a low level.

In the detection circuit 117, when n1 is a or b and m1 is any integer from 1 to M, a detection signal Vout[n1m1] output from the piezoelectric element 111f[n1m1] is supplied via the internal wiring LHs. The detection circuit 117 then generates the residual vibration signal NES based on the detection signal Vout[n1m1]. The residual vibration signal NES is an analog signal.

The detection circuit 117 may have a configuration in which, for example, a negative feedback amplifier for amplifying the detection signal Vout, a low-pass filter for attenuating high-frequency components of the detection signal Vout, and a voltage follower that performs impedance conversion and outputs the residual vibration signal NES with low impedance are provided.

The generation circuit 190 generates residual vibration information NEI regarding residual vibration, based on the residual vibration signal NES. The residual vibration information NEI is a digital signal. For example, the generation circuit 190 samples the residual vibration signal NES at regular periods and generates, as the residual vibration information NEI, information that associates time information indicating, with reference to any start time point, a time at sampling with a value indicating a potential obtained by the sampling.

### 1-6. Operation of Ink Jet Head HU

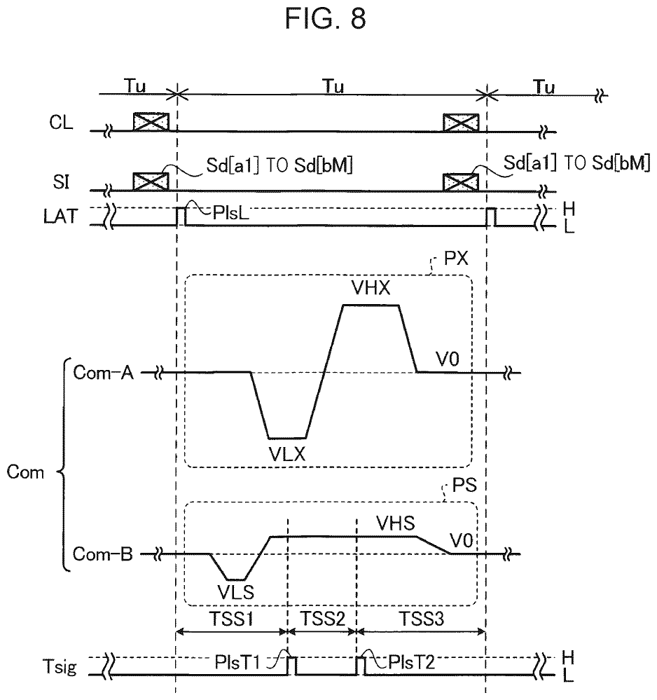

Hereinafter, the operation of the ink jet head HU will be described with reference to FIG. 8. In the present embodiment, an operation period of the evaluation apparatus 20 includes one or a plurality of recording periods Tu. It is assumed that the evaluation apparatus 20 according to the present embodiment executes, in each recording period Tu, one of driving of the piezoelectric elements 111f, and driving of the determination target piezoelectric element 111f-H in a preparation process for an ejection state determination process and detection of residual vibration.

FIG. 8 is a timing chart illustrating the operation of the ink jet head HU in the recording period Tu. As shown in FIG. 8, the control circuit 21 outputs the latch signal LAT having a pulse PlsL. Consequently, the control circuit 21 defines the recording period Tu as a period from a rising edge of the pulse PlsL to a rising edge of the next pulse PlsL.

The printing signal SI includes individual designation signals Sd[a1] to Sd[bM] that designate drive modes of piezoelectric elements 111f[a1] to 111f[bM] in each recording period Tu. Then, as shown in FIG. 8, the control circuit 21 supplies, prior to the start of the recording period Tu, the printing signal SI including the individual designation signals Sd[a1] to Sd[bM] to the coupling state designation circuit 116 in synchronization with a clock signal CL. In this case, when n1 is a or b and m1 is any integer from 1 to M, the coupling state designation circuit 116 generates coupling state designation signals SLa[n1m1], SLb[n1m1], and SLs[n1m1] in the recording period Tu, based on an individual designation signal Sd[n1m1].

When n1 is a or b and m1 is any integer from 1 to M, the individual designation signal Sd[n1m1] according to the present embodiment is a signal for designating, in each recording period Tu, for the piezoelectric element 111f[n1m1], any one drive mode among three drive modes, namely ejection of ink, non-ejection of ink, and driving as the determination target in the ejection state determination process.

As shown in FIG. 8, the drive signal generation circuit 2 outputs the drive signal Com-A having an ejection waveform PX. The ejection waveform PX has the lowest potential VLX and the highest potential VHX. The ejection waveform PX has potentials at the start and at the end set to a reference potential V0.

Then, on the premise that n1 is a or b and m1 is any integer from 1 to M, when the individual designation signal Sd[n1m1] designates ejection of ink for the piezoelectric element 111f[n1m1], the coupling state designation circuit 116 sets the coupling state designation signal SLa[n1m1] to a high level in the recording period Tu, and sets the coupling state designation signals SLb[n1m1] and SLs[n1m1] to a low level in the recording period Tu. In this case, the nozzle Nz[n1m1] ejects ink in the recording period Tu, and a dot is formed on the medium PP.

As shown in FIG. 8, the drive signal generation circuit 2 outputs the drive signal Com-B having an inspection waveform PS provided in the recording period Tu. In the present embodiment, the inspection waveform PS is defined such that a potential difference between the highest potential VHS and the lowest potential VLS of the inspection waveform PS is smaller than a potential difference between the highest potential VHX and the lowest potential VLX of the ejection waveform PX. Specifically, on the premise that n1 is a or b and m1 is any integer from 1 to M, when the drive signal Com-B having the inspection waveform PS is supplied to the piezoelectric element 111f[n1m1], the inspection waveform PS is defined such that the piezoelectric element 111f[n1m1] is driven to an extent such that ink is not ejected from the nozzle Nz[n1m1]. The inspection waveform PS has potentials at the start and at the end set to the reference potential V0.

In addition, the control circuit 21 outputs the period designation signal Tsig having a pulse PlsT1 and a pulse PlsT2. Consequently, the control circuit 21 divides the recording period Tu into a control period TSS1 from the start of the pulse PlsL to the start of the pulse PlsT1, a control period TSS2 from the start of the pulse PlsT1 to the start of the pulse PlsT2, and a control period TSS3 from the start of the pulse PlsT2 to the start of the next pulse PlsL.

Then, on the premise that n1 is a or b and m1 is any integer from 1 to M, when the individual designation signal Sd[n1m1] designates the nozzle Nz[n1m1] as the determination target nozzle Nz-H, the coupling state designation circuit 116 sets the coupling state designation signal SLa[n1m1] to a low level in the recording period Tu, sets the coupling state designation signal SLb[n1m1] to a high level in the control periods TSS1 and TSS3 and to a low level in the control period TSS2, respectively, and sets the coupling state designation signal SLs[n1m1] to a low level in the control period TSS1 and the control period TSS3 and to a high level in the control period TSS2, respectively.

In this case, the determination target piezoelectric element 111f-H is driven in the control period TSS1 by the drive signal Com-B having the inspection waveform PS. The piezoelectric element 111f is displaced in the control period TSS1 by the drive signal Com-B having the inspection waveform PS. As a result, vibration occurs in the determination target pressure chamber CV-H, and the vibration remains in the control period TSS2. Then, in the control period TSS2, the lower electrode Zd of the determination target piezoelectric element 111f-H changes in potential in accordance with residual vibration occurring in the determination target pressure chamber CV-H. In other words, in the control period TSS2, the lower electrode Zd of the determination target piezoelectric element 111f-H exhibits a potential corresponding to an electromotive force of the piezoelectric element 111f caused by the residual vibration occurring in the determination target pressure chamber CV-H. Then, the potential of the lower electrode Zd can be detected, in the control period TSS2, as the detection signal Vout.

### 1-7. Regarding Correspondence Information CI

In the system SYS used to eject ink using the ink jet head HU, it is required to provide waveform information WV indicating the drive waveform corresponding to the usage condition of the user U, such as a type of ink or a type of the ink jet head HU. This is because, when the usage condition of the user U changes, even in a case where the drive waveform indicated by the same waveform information WV is applied to the ink jet head HU, a quality of an image formed on the medium PP may change. Here, when the correspondence information CI includes usage condition information JI indicating the same usage condition as a usage condition of a certain user U_x, the waveform information WV corresponding to the usage condition information JI need only be provided to the user U_x. Herein, x is any integer from 1 to 3. However, when the usage condition information JI indicating the same usage condition as the usage condition of the user U_x is not included, in other words, when the usage condition of the user U_x is a usage condition unknown to the head manufacturer, the waveform information WV corresponding to the usage condition of the user U_x cannot be provided.

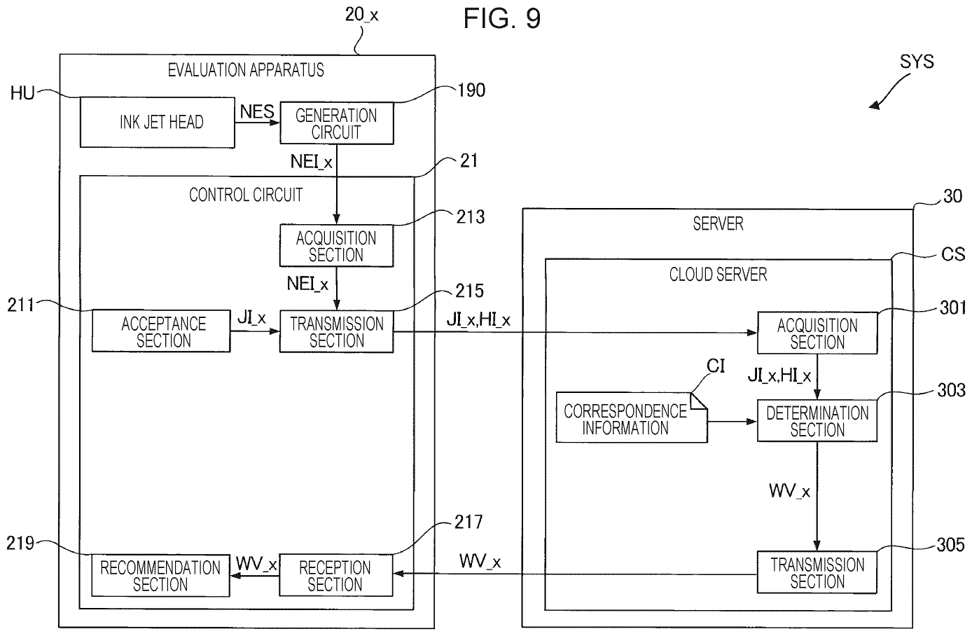

Here, the inventor found that the usage condition of the user U_x is reflected in residual vibration. Specifically, since residual vibration fluctuates depending on a natural vibration period Tc of the ink jet head HU and on physical properties of ink such as the viscosity of ink, the inventor found that, when residual vibrations corresponding to respective two usage conditions are similar, the two usage conditions can be said to be similar. Therefore, in the present embodiment, based on a degree of similarity between ejection characteristics indicated by characteristic information HI of the ink jet head HU used in accordance with the usage condition of the user U_x and ejection characteristics indicated by characteristic information HI defined in the correspondence information CI, the waveform information WV indicating the drive waveform corresponding to the usage condition of the user U_x is determined. The functions and operations of the system SYS in the first embodiment will be described with reference to FIGS. 9 to 14.

### 1-8. Functions and Operations of System SYS

FIG. 9 is a diagram showing the functions of the system SYS. The control circuit 21 reads out the provision program PM2 and, by executing the read-out provision program PM2, functions as an acceptance section 211, an acquisition section 213, a transmission section 215, a reception section 217, and a recommendation section 219. The server 30 reads out the virtualization program VM and, by executing the read-out virtualization program VM, functions as the cloud server CS. The cloud server CS reads out the control program PM1 and, by executing the control program PM1, functions as an acquisition section 301, a determination section 303, and a transmission section 305.

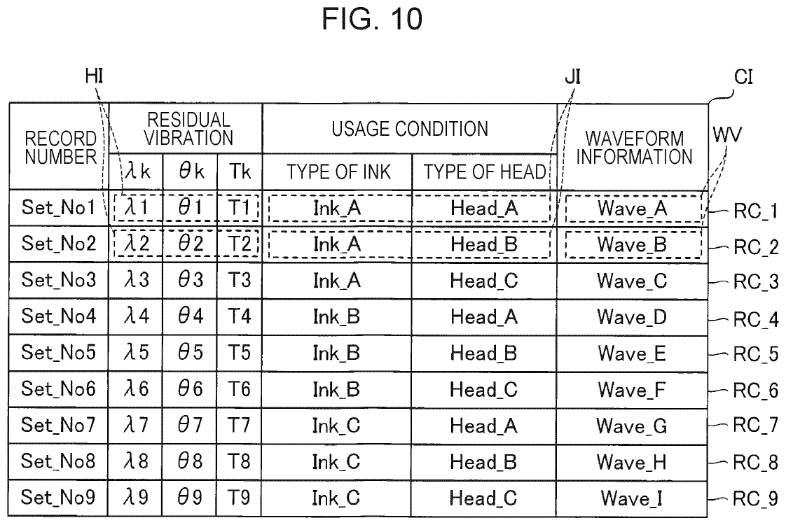

By executing the control program PM1, the cloud server CS accesses the correspondence information CI. The correspondence information CI will be described with reference to FIG. 10.

FIG. 10 is a diagram illustrating contents of the correspondence information CI. The correspondence information CI has one or more records RC having a character string indicating a record number, characteristic information HI indicating characteristics of residual vibration, usage condition information JI indicating a usage condition, and waveform information WV indicating a drive waveform. The correspondence information CI shown in FIG. 10 includes records RC_1 to RC_9. Hereinafter, records included in the correspondence information CI may be referred to, without distinction, as the record RC. Additionally, the number of records RC included in the correspondence information CI may be referred to as N. Further, for any integer n from 1 to N, a record may be referred to as a record RC_n.

The character string indicating the record number is information for identifying the record RC. The record RC is registered by one or both of the head manufacturer and the user U. Hereinafter, a user who registers the record RC may be referred to as a registered user Ur. The registered user Ur includes the head manufacturer. In addition, registered users Ur of two or more records RC may be the same user U or the same head manufacturer, or may be different users U.

The characteristic information HI has, for any integer n from 1 to N, an amplitude value λn, a phase value θn, and a period value Tn of residual vibration of the ink jet head HU used by the registered user Ur in accordance with the usage condition indicated by the usage condition information JI. Hereinafter, the amplitude value λn, the phase value θn, and the period value Tn may be collectively referred to, without distinction, as a characteristic value. Residual vibration of the ink jet head HU is an example of “ejection characteristics of the ink jet head”. The characteristic information HI is an example of “a plurality of characteristic values indicating characteristics of residual vibration”.

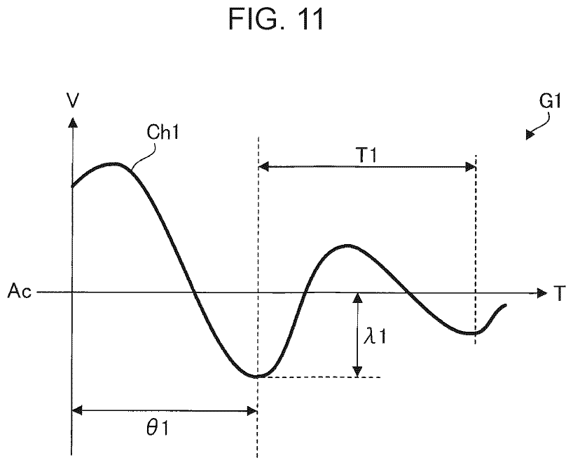

The characteristic information HI registered in each record RC of the correspondence information CI indicates characteristics of residual vibration obtained by applying to the ink jet head HU the drive signal Com having the same drive waveform. Hereinafter, this drive waveform may be referred to as a “sample drive waveform”. The sample drive waveform may be the inspection waveform PS shown in FIG. 8, or may be a pulse waveform in which an amplitude of residual vibration becomes large. Additionally, when the sample drive waveform is applied to the ink jet head HU, ink may be ejected from the nozzle Nz, or ink may not be ejected from the nozzle Nz. Further, residual vibration obtained by applying to the ink jet head HU the drive signal Com having the sample drive waveform may be referred to as “sample residual vibration”. In addition, the residual vibration information NEI indicating the sample residual vibration may be referred to as “sample residual vibration information NEI”. Each characteristic value included in the characteristic information HI will be described with reference to FIG. 11.

FIG. 11 is a graph illustrating each characteristic value included in the characteristic information HI. A horizontal axis of a graph G1 shown in FIG. 11 indicates time, and a vertical axis of the graph G1 indicates a potential. Residual vibration characteristics Ch1 shown in the graph G1 indicate characteristics of residual vibration when the sample drive waveform is applied to the ink jet head HU under the usage condition indicated by the usage condition information JI of the record RC_1.

For any integer n from 1 to N, the amplitude value λn is an absolute value of a difference between a potential at a second extremum value of the residual vibration and a potential Ac at a center of amplitude of the residual vibration. The phase value θn is a period from a start time point of the residual vibration to a time point at which the residual vibration becomes the second extremum value. The fact that the residual vibration becomes an amplitude extremum value can be said to occur when, in a case where the residual vibration is regarded as a sinusoidal wave whose amplitude attenuates, a phase of the residual vibration is 90 degrees or 270 degrees. The period value Tn is a period from the time point at which the residual vibration becomes the second extremum value to a time point at which the residual vibration becomes the fourth extremum value.

However, the amplitude value λn is not limited to the absolute value of the difference between the potential at the second extremum value of the residual vibration and the potential Ac. For example, with i being an integer of 1 or greater, the amplitude value λn may be an absolute value of a difference between a potential at an i-th extremum value of the residual vibration and a potential at an (i+1)-th extremum value of the residual vibration.

In addition, the phase value θn is not limited to the period from the start time point of the residual vibration to the time point at which the residual vibration becomes the second extremum value. For example, the phase value θn may be a period from the start time point of the residual vibration to a time point at which the potential becomes the potential Ac.

Additionally, the period value Tn is not limited to the period from the time point at which the residual vibration becomes the second extremum value to the time point at which the residual vibration becomes the fourth extremum value. For example, with i being an integer of 1 or greater, the period value Tn may be a period from the time point at which the residual vibration becomes the i-th extremum value to the time point at which the residual vibration becomes the (i+2)-th extremum value.

However, it is preferable that the amplitude value λn, the phase value θn, and the period value Tn are all large, in order to make the influence of noise relatively small.

The description returns to FIG. 10. The usage condition information JI is information indicating the usage condition of the ink jet head HU used by the registered user Ur. In the first embodiment, the usage condition information has a character string indicating a type of ink and a character string indicating a type of the ink jet head HU. Hereinafter, a type of the ink jet head HU may be referred to as a “type of head”.

The character string indicating the type of ink is a character string for uniquely identifying ink used by the ink jet head HU used by the registered user Ur. The character string indicating the type of ink is, for example, an ink name, an ink product name, and an ink manufacturer name. In the present specification, in order to simplify the description, the character string indicating the type of ink is indicated as “Ink_a”. Herein, a is any single character. The character string indicating the type of ink is an example of “information indicating a type of ink”.

The character string indicating the type of head is a character string for uniquely identifying the ink jet head HU used by the registered user Ur. The character string indicating the type of head is, for example, a character string indicating a head name or a head serial number. In the present specification, in order to simplify the description, the character string indicating the type of head is indicated as “Head_a”. Herein, a is any single character. The character string indicating the type of head is an example of “information indicating a type of the ink jet head”.

The waveform information WV is information indicating a drive waveform corresponding to the usage condition of the ink jet head HU used by the registered user Ur. The waveform information WV has termination information including information indicating a termination time of each period of the drive waveform and information indicating a termination potential. For example, when the waveform information WV is information indicating the ejection waveform PX, the waveform information WV has termination information of a period for maintaining the reference potential V0 from the start time point of the recording period Tu, termination information of a period for decreasing the potential from the reference potential V0 to the lowest potential VLX, termination information of a period for maintaining the lowest potential VLX, termination information of a period for increasing the potential from the lowest potential VLX to the highest potential VHX, termination information of a period for maintaining the highest potential VHX, termination information of a period for decreasing the potential from the highest potential VHX to the reference potential V0, and termination information of a period for maintaining the reference potential V0 until an end time point of the recording period Tu. In the present specification, in order to simplify the description, the waveform information WV is indicated as “Wave_a”. Herein, a is any single character.

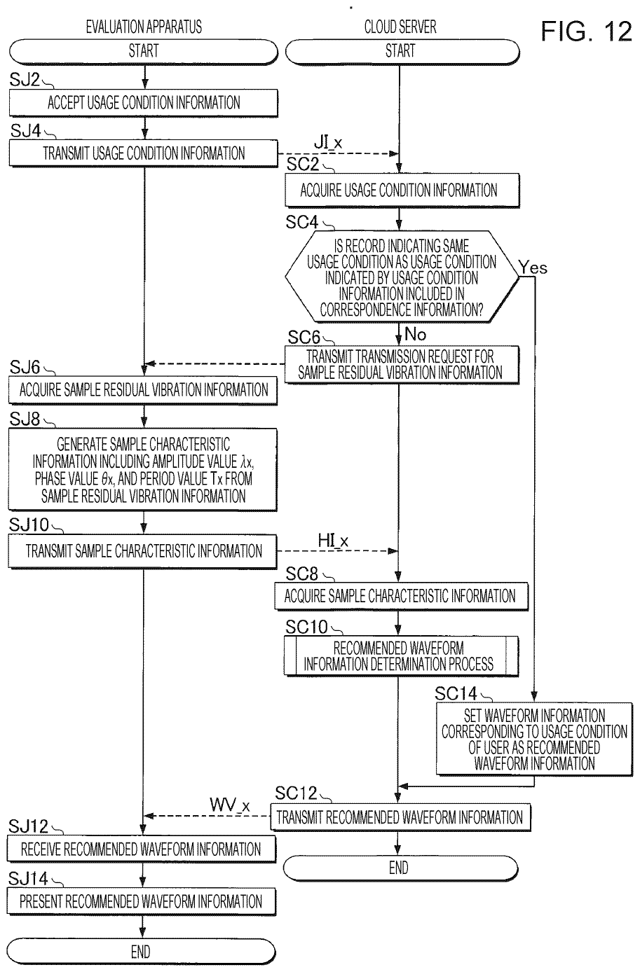

FIG. 12 is a flowchart showing the operations of the system SYS. In step SJ2, the control circuit 21 of an evaluation apparatus 20_x operated by the user U_x functions as the acceptance section 211 and, based on operation information by the input device 26 of the user U_x, accepts usage condition information JI_x. Herein, x is any integer from 1 to 3. In the following description, similarly to the usage condition information JI_x, information regarding the evaluation apparatus 20_x may be appended with “_x”.

The user U_x is an example of a “specific user”. The user U_x may or may not register, previously, the record RC included in the correspondence information CI.

As specific processing of step SJ2, the user U_x operates the input device 26 and inputs the character string indicating the type of ink used by the ink jet head HU used by the user U_x and the character string indicating the type of head used by the user U_x, which are included in the usage condition information JI_x.

After the end of the processing in step SJ2, in step SJ4, the control circuit 21 functions as the transmission section 215 and transmits the usage condition information JI_x to the cloud server CS. After the end of the processing in step SJ4, the control circuit 21 waits for a response from the cloud server CS.

After the end of the processing in step SC2, in step SC2, the cloud server CS functions as the acquisition section 301 and acquires the usage condition information JI_x by receiving the usage condition information JI_x from the evaluation apparatus 20_x. Next, the cloud server CS determines whether or not the record RC indicating the same usage condition as the usage condition indicated by the usage condition information JI_x is included in the correspondence information CI. More specifically, for each integer n from 1 to N, the control circuit 31 determines whether or not there is a record RC_n in which the character string indicating the type of ink of the record RC_n coincides with the character string indicating the type of ink of the usage condition information JI_x, and the character string indicating the type of head of the record RC_n coincides with the character string indicating the type of head of the usage condition information JI_x.

When a determination result of step SC4 is negative, that is, when the record RC indicating the same usage condition as the usage condition indicated by the usage condition information JI_x is not included in the correspondence information CI, in step SC6, the cloud server CS transmits to the evaluation apparatus 20_x a transmission request for sample residual vibration information NEI_x. After the end of the processing in step SC6, the cloud server CS waits for a response from the evaluation apparatus 20_x.

Upon receiving the transmission request for the sample residual vibration information NEI_x, in step SJ6, the evaluation apparatus 20_x functions as the acquisition section 213 and acquires the sample residual vibration information NEI_x from the generation circuit 190. Specifically, the control circuit 21 of the evaluation apparatus 20_x sets any one of the 2M piezoelectric elements 111f corresponding to the 2M nozzles Nz as the determination target piezoelectric element 111f-H, and applies the sample drive waveform to the determination target piezoelectric element 111f-H. The transmission request for the sample residual vibration information NEI_x transmitted in step SC6 may include waveform information indicating the sample drive waveform.

After the end of the processing in step SJ6, in step SJ8, the evaluation apparatus 20_x generates sample characteristic information HI_x including an amplitude value λx, a phase value θx, and a period value Tx from the sample residual vibration information NEI_x. Next, in step SJ10, the evaluation apparatus 20_x functions as the transmission section 215 and transmits the sample characteristic information HI_x to the cloud server CS. After the end of the processing in step SJ10, the control circuit 21 waits for a response from the cloud server CS. The sample residual vibration information NEI_x acquired in step SJ6 may be transmitted to the cloud server CS, and step SJ8 of generating the sample characteristic information HI_x from the sample residual vibration information NEI_x may be performed on a cloud server CS side.

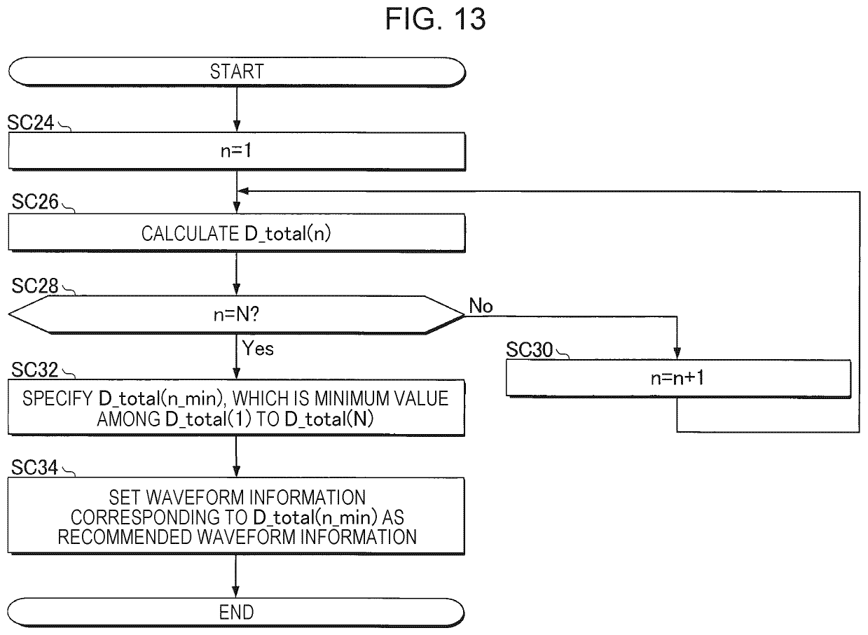

In step SC8, the cloud server CS functions as the acquisition section 301 and acquires the sample characteristic information HI_x by receiving the sample characteristic information HI_x from the evaluation apparatus 20_x. Next, the cloud server CS functions as the determination section 303 and, in step SC10, executes a recommended waveform information determination process. The recommended waveform information determination process will be described with reference to FIG. 13.

FIG. 13 is a flowchart showing an example of the recommended waveform information determination process. The recommended waveform information determination process is a process of determining the drive waveform corresponding to the usage condition of the user U_x. Hereinafter, the waveform information WV indicating the drive waveform corresponding to the usage condition of the user U_x may be referred to as recommended waveform information WV_x. The recommended waveform information WV_x is an example of “output condition information indicating an output condition corresponding to the usage condition of the specific user”. The drive waveform indicated by the recommended waveform information WV_x is an example of “an output condition corresponding to the usage condition of the specific user”.

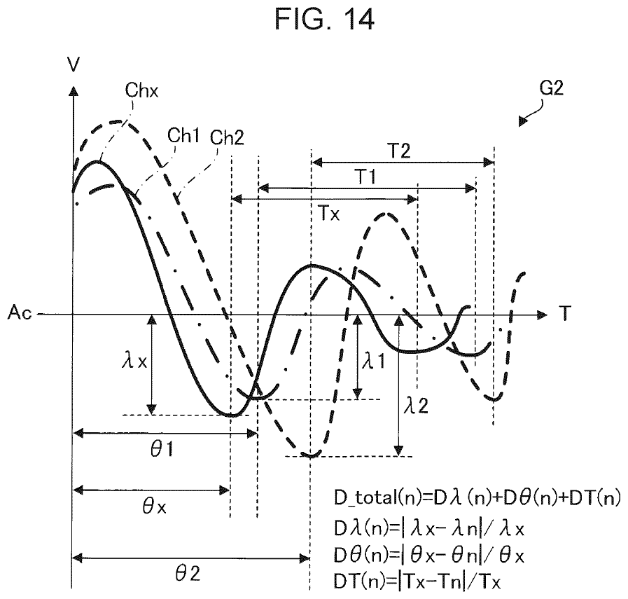

In step SC24, the cloud server CS assigns 1 to a variable n. Then, in step SC26, the cloud server CS calculates a degree of similarity D_total(n) between the characteristics of residual vibration indicated by the sample characteristic information HI_x and the characteristics indicated by the characteristic information HI of the record RC_n. A calculation example of the degree of similarity D_total(n) will be described with reference to FIG. 14.

FIG. 14 is a graph illustrating the calculation example of the degree of similarity D_total(n). The cloud server CS calculates the degree of similarity D_total(n) in accordance with Equation (1) below.

$$D\_total ( n ) = D λ ( n ) + D θ ( n ) + D T ( n ) \qquad ( 1 )$$

The cloud server CS calculates Dλ(n), Dθ(n), and DT(n) in accordance with Equations (2), (3), and (4) below.

$$D λ ( n ) = \vert λ x - λ n \vert / λ x \qquad ( 2 )$$

$$D θ ( n ) = \vert θ x - θ n \vert / θ x \qquad ( 3 )$$

$$DT ( n ) = \vert Tx - T n \vert / Tx \qquad ( 4 )$$

Here, |a| means an absolute value of a. When the characteristics of residual vibration indicated by the sample characteristic information HI_x and the characteristics indicated by the characteristic information HI of the record RC_n coincide, Dλ(n), Dθ(n), and DT(n) are zero. Accordingly, the degree of similarity D_total(n) becomes closer to zero as the characteristics of residual vibration indicated by the sample characteristic information HI_x and the characteristics indicated by the characteristic information HI of the record RC_n become more similar, and becomes greater as they become more different.

A graph G2 shown in FIG. 14 indicates the residual vibration characteristics Ch1, residual vibration characteristics Ch2, and residual vibration characteristics Chx. The residual vibration characteristics Ch2 indicate characteristics of residual vibration when the sample drive waveform is applied to the ink jet head HU under the usage condition indicated by the usage condition information JI of the record RC_2. The residual vibration characteristics Chx indicate characteristics of residual vibration indicated by the sample characteristic information HI_x.

The record RC_1 is an example of a “first set”, and the record RC_2 is an example of a “second set”. The usage condition indicated by the usage condition information JI of the record RC_1 is an example of a “first usage condition”, and the usage condition indicated by the usage condition information JI of the record RC_2 is an example of a “second usage condition”. Characteristic values included in the characteristic information HI of the record RC_1 are an example of “a plurality of characteristic values indicating ejection characteristics of an ink jet head used in accordance with the first usage condition”. Characteristic values included in the characteristic information HI of the record RC_2 are an example of “a plurality of characteristic values indicating ejection characteristics of an ink jet head used in accordance with the second usage condition”. The waveform information WV of the record RC_1 is an example of “first output condition information”, and the waveform information WV of the record RC_2 is an example of “second output condition information”. The degree of similarity D_total(1) is an example of a “first degree of similarity”, and the degree of similarity D_total(2) is an example of a “second degree of similarity”.

However, the method of calculating the degree of similarity D_total(n) is not limited to Equation (1) described above. For example, among the first term, the second term, and the third term in Equation (1), any one term may be absent.

The description returns to FIG. 13. After the end of the processing in step SC26, in step SC28, the cloud server CS determines whether or not a value of the variable n coincides with N. When the determination result of step SC28 is negative, in other words, when the value of the variable n is less than N, in step SC30, the cloud server CS adds 1 to the value of the variable n and returns the processing to step SC26.

When the determination result of step SC28 is affirmative, in step SC32, the cloud server CS specifies D_total(n_min), which is a minimum value among the degree of similarities D_total(1) to D_total(N). Herein, n_min is any integer from 1 to N. After the end of the processing in step SC32, in step SC34, the cloud server CS sets, as the recommended waveform information WV_x, the waveform information WV corresponding to the degree of similarity D_total(n_min). The waveform information WV corresponding to the degree of similarity D_total(n_min) is waveform information WV included in a record RC_n_min. After the end of the processing in step SC34, the cloud server CS ends a series of processes shown in FIG. 13.

The description returns to FIG. 12. After the end of the processing in step SC10, in step SC12, the cloud server CS transmits to the evaluation apparatus 20_x the recommended waveform information WV_x set in the processing in step SC10. After the end of the processing in step SC12, the cloud server CS ends a series of processes shown in FIG. 12.

When the determination result of step SC4 is affirmative, in step SC14, the cloud server CS sets, as the recommended waveform information WV_x, the waveform information WV corresponding to the usage condition of the user U_x. The waveform information WV corresponding to the usage condition of the user U_x is the waveform information WV of the record RC indicating the same usage condition as the usage condition indicated by the usage condition information JI acquired in step SC2. After the end of the processing in step SC14, the cloud server CS executes the processing in step SC12 and ends the series of processes shown in FIG. 12.

In step SJ12, the evaluation apparatus 20_x functions as the reception section 217 and receives the recommended waveform information WV_x from the cloud server CS. Next, in step SJ14, the evaluation apparatus 20_x, as the recommendation section 219, recommends the recommended waveform information WV_x to the user U_x. As a specific example of the processing in step SJ12, the evaluation apparatus 20_x supplies to the ink jet head HU, for example, the drive signal Com having the drive waveform indicated by the recommended waveform information WV_x. Alternatively, the evaluation apparatus 20_x may display, on the display device 27, an image indicating the shape of the drive waveform indicated by the recommended waveform information WV_x. After the end of the processing in step SJ14, the evaluation apparatus 20_x ends the series of processes shown in FIG. 12.

The operations of the system SYS are not limited to the series of processes shown in FIGS. 12 and 13. For example, in the series of processes shown in FIGS. 12 and 13, the control circuit 21 of the evaluation apparatus 20_x generates, in step SJ8, the sample characteristic information HI_x from the sample residual vibration information NEI_x, but the present disclosure is not limited to this. For example, the generation circuit 190 of the evaluation apparatus 20_x may generate the sample characteristic information HI_x from the residual vibration signal NES.

In addition, in the series of processes shown in FIGS. 12 and 13, the waveform information WV corresponding to the degree of similarity D_total(n_min) is provided to the user U_x as the recommended waveform information WV_x, but the present disclosure is not limited to this. For example, the cloud server CS associates any one of the degree of similarities D_total(1) to D_total(N) with each record RC of the correspondence information CI. Then, the cloud server CS transmits the correspondence information CI to the evaluation apparatus 20_x. The evaluation apparatus 20_x may display, on the display device 27, an image indicating a result of sorting N records RC of the correspondence information CI in ascending order of degree of similarity. Alternatively, the evaluation apparatus 20_x may display, on the display device 27, an image corresponding to a drive waveform obtained, as a result calculated from the N records RC of the correspondence information CI, for example, by averaging each waveform component (amplitude, period, phase) of the waveform information WV in about two to five records RC having a high degree of similarity.

### 1-9. Summary of First Embodiment

Hereinafter, a summary of the first embodiment will be described using the “specific user” denoted as the user U_x, the “first set” denoted as the record RC_1, and the “second set” denoted as the record RC_2.

The system SYS is a system used to eject ink using the ink jet head HU. The system SYS includes the storage circuit 32 corresponding to a “storage section” and the control circuit 31 that functions as the acquisition section 301 and the determination section 303. The storage circuit 32 stores the correspondence information CI. The correspondence information CI defines combinations of the characteristic information HI indicating characteristics of residual vibration of the ink jet head HU used in accordance with one or more usage conditions, the usage condition information JI indicating the one or more usage conditions, and the waveform information indicating the drive waveform corresponding to the one or more usage conditions. The acquisition section 301 acquires the sample characteristic information HI_x indicating ejection characteristics of the ink jet head HU used in accordance with the usage condition of the user U_x and the usage condition information JI_x indicating the usage condition of the user U_x. The determination section 303 determines, with reference to the correspondence information CI, the recommended waveform information WV_x indicating the drive waveform corresponding to the usage condition of the user U_x, based on the degree of similarity D_total between the ejection characteristics indicated by the sample characteristic information HI_x acquired by the acquisition section 301 and the ejection characteristics indicated by the characteristic information HI defined in the correspondence information CI.

According to the first embodiment, even when the usage condition of the user U_x is unknown to the head manufacturer, by utilizing that the usage condition of the user U_x is reflected in residual vibration, the recommended waveform information WV_x indicating the drive waveform corresponding to the usage condition of the user U_x can be provided to the user U_x.

In addition, the usage condition information JI includes information indicating the type of ink.

According to the first embodiment, the recommended waveform information WV_x corresponding to the type of ink used by the user U_x can be provided to the user U_x.

Further, the usage condition information JI includes information indicating the type of head.

According to the first embodiment, the recommended waveform information WV_x corresponding to the type of head used by the user U_x can be provided to the user U_x.

Additionally, the recommended waveform information WV_x is the waveform information WV indicating the drive waveform to be applied to the ink jet head HU corresponding to the usage condition of the user U_x.

According to the first embodiment, by providing the recommended waveform information WV_x to the user U_x, the user U_x can apply to the ink jet head HU the drive waveform corresponding to the usage condition of the user U_x.

Further, the characteristic information HI is a plurality of characteristic values indicating the residual vibration characteristics of the ink jet head HU used in accordance with the usage condition of the user U_x.

As described above, since the usage condition of the user U_x is reflected in residual vibration, by determining whether or not residual vibrations corresponding to two usage conditions are similar, the two usage conditions can be said to be similar. However, when determining whether or not residual vibrations corresponding to two usage conditions are similar, even in a case where one characteristic value, for example, a maximum potential, is close between residual vibrations, it cannot necessarily be said that overall features of the residual vibrations are similar. According to the first embodiment, as compared with an aspect in which one characteristic value indicating the characteristics of residual vibration is used, whether or not overall residual vibrations corresponding to two usage conditions are similar can be determined with high accuracy. By being able to determine with high accuracy whether or not overall residual vibrations corresponding to two usage conditions are similar, accuracy of determination as to whether or not the two usage conditions are similar can be improved.

The plurality of characteristic values are a plurality of values among the value of amplitude, the value of phase, and the value of period of the residual vibration, the correspondence information CI has the record RC_1 and the record RC_2, and the determination section 303 calculates the degree of similarity D_total(1), based on the plurality of characteristic values included in the record RC_1 and the plurality of characteristic values indicated by the sample characteristic information HI_x acquired by the acquisition section 301. Additionally, the determination section 303 calculates the degree of similarity D_total(2) based on the plurality of characteristic values included in the record RC_2 and the plurality of characteristic values indicated by the sample characteristic information HI_x acquired by the acquisition section 301. The determination section 303 determines, based on a comparison result between the degree of similarity D_total(1) and the degree of similarity D_total(2), either the waveform information WV of the record RC_1 or the waveform information WV of the record RC_2 as the recommended waveform information WV_x indicating the drive waveform corresponding to the usage condition of the user U_x.

According to the first embodiment, among the waveform information WV of the record RC_1 and the waveform information WV of the record RC_2, waveform information WV indicating the drive waveform corresponding to residual vibration close to residual vibration indicated by the sample characteristic information HI_x can be determined as the recommended waveform information WV_x.

In addition, the determination section 303 determines, when the usage condition information JI_x acquired by the acquisition section 301 and the usage condition information JI defined in the correspondence information CI coincide, the waveform information WV defined in the correspondence information CI as the recommended waveform information WV_x. On the other hand, the determination section 303 determines, when the usage condition information JI_x acquired by the acquisition section 301 and the usage condition information JI defined in the correspondence information CI do not coincide, the recommended waveform information WV_x indicating the drive waveform corresponding to the usage condition of the user U_x, based on the degree of similarity between the ejection characteristics indicated by the sample characteristic information HI_x acquired by the acquisition section 301 and the ejection characteristics indicated by the characteristic information HI defined in the correspondence information CI.

According to the first embodiment, whether the usage condition information JI_x acquired by the acquisition section 301 and the usage condition information JI defined in the correspondence information CI coincide or do not coincide, the recommended waveform information WV_x indicating the drive waveform corresponding to the usage condition of the user U_x can be provided to the user U_x.

### 2. MODIFICATION EXAMPLES

Each aspect exemplified above can be variously modified. Specific aspects of modification that can be applied to each embodiment described above will be exemplified below. Two or more aspects optionally selected from the following examples can be combined as appropriate insofar as the aspects are not mutually contradictory.

### 2-1. First Modification Example

In the first embodiment, the cloud server CS specifies, in step SC32, D_total(n_min), which is the minimum value among the degree of similarities D_total(1) to D_total(N), but the present disclosure is not limited to this. For example, for any integer n from 1 to N, when the degree of similarity D_total(n) is equal to or less than a predetermined threshold value, the cloud server CS may set the waveform information WV corresponding to the degree of similarity D_total(n) as the recommended waveform information WV_x. The predetermined threshold value is set in advance by the head manufacturer.

### 2-2. Second Modification Example

In each aspect described above, the usage condition information JI includes information indicating the type of ink and information indicating the type of head, but the present disclosure is not limited to this. For example, instead of or in addition to information indicating the type of ink and information indicating the type of head, one or both of temperature and humidity when the ink jet head HU is used may be included in the usage condition information JI.

### 2-3. Third Modification Example

In each aspect described above, the characteristic information HI has a plurality of characteristic values indicating the characteristics of residual vibration, but the present disclosure is not limited to this. For example, the characteristic information HI may be the residual vibration information NEI indicating residual vibration. When the characteristic information HI is the residual vibration information NEI, the determination section 303 determines the recommended waveform information WV_x, based on the degree of similarity between the sample residual vibration information NEI_x acquired by the acquisition section 301 and the residual vibration information NEI defined in the correspondence information CI. In addition, as the characteristic information HI, information regarding the drive waveform itself may be used rather than information regarding the residual vibration.

### 2-4. Fourth Modification Example

In each aspect described above, the recommended waveform information WV_x indicating the drive waveform corresponding to the usage condition of the user U_x is an example of “output condition information”, but the present disclosure is not limited to this. For example, the “output condition information” may have, instead of or in addition to the recommended waveform information WV_x, any one or a plurality of pieces of information indicating an ejection amount, an ejection speed, and an ejection stability corresponding to the usage condition of the user U_x. The information indicating the ejection stability is, for example, one piece of information among information indicating stable ejection, information indicating unstable ejection, and information indicating that ejection is impossible. When the “output condition information” has any one or a plurality of pieces of information indicating the ejection amount, the ejection speed, and the ejection stability, the correspondence information CI also includes the information included in the “output condition information”.

### 2-5. Fifth Modification Example

In each aspect described above, the characteristic information HI has a plurality of characteristic values indicating the characteristics of residual vibration, but the present disclosure is not limited to this. For example, the characteristic information HI may be a plurality of characteristic values indicating characteristics of a pressure fluctuation waveform generated when ink is supplied to the ink jet head HU. The plurality of characteristic values indicating characteristics of the pressure fluctuation waveform are a plurality of values among an amplitude value, a phase value, and a period value of the pressure fluctuation waveform. Alternatively, the characteristic information HI may be waveform information indicating the drive waveform to be applied to the ink jet head HU. 2-6. Sixth Modification Example

In each aspect described above, a serial type ink jet printer 10 in which the ink jet head HU reciprocates in the direction along the X-axis is exemplified, but the present disclosure is not limited to such an aspect. The ink jet printer 10 may be a line type liquid ejection apparatus in which a plurality of nozzles Nz are distributed over the entire width of the medium PP.

### 2-7. Other Modification Examples

The ink jet printer 10 described above can be employed in various apparatuses such as a facsimile apparatus and a copier in addition to an apparatus dedicated to printing. Moreover, applications of a recording apparatus of the present disclosure are not limited to printing. For example, a recording apparatus that ejects a solution of a colorant is utilized as a manufacturing apparatus that forms a color filter of a liquid-crystal display apparatus. Additionally, a recording apparatus that ejects a solution of a conductive material is utilized as a manufacturing apparatus that forms wiring and electrodes of a wiring substrate.

What is claimed is:

1. A system used to eject ink using an ink jet head, the system comprising:
a storage section that stores correspondence information that defines combinations of characteristic information indicating ejection characteristics of an ink jet head used in accordance with one or more usage conditions, usage condition information indicating the one or more usage conditions, and output condition information indicating an output condition corresponding to the one or more usage conditions;
an acquisition section that acquires characteristic information indicating ejection characteristics of an ink jet head used in accordance with a usage condition of a specific user and usage condition information indicating the usage condition of the specific user; and
a determination section that determines, with reference to the correspondence information, output condition information indicating an output condition corresponding to the usage condition of the specific user, based on a degree of similarity between the ejection characteristics indicated by the characteristic information acquired by the acquisition section and the ejection characteristics indicated by the characteristic information defined in the correspondence information.

2. The system according to claim 1, wherein
the usage condition information includes information indicating a type of ink.

3. The system according to claim 1, wherein
the usage condition information includes information indicating a type of the ink jet head.

4. The system according to claim 1, wherein
the output condition information includes waveform information indicating a drive waveform to be applied to the ink jet head.

5. The system according to claim 1, wherein
the characteristic information includes a plurality of characteristic values indicating characteristics of residual vibration of the ink jet head.

6. The system according to claim 5, wherein
the plurality of characteristic values are a plurality of values among a value of amplitude, a value of phase, and a value of period of the residual vibration,
the one or more usage conditions include a first usage condition and a second usage condition,
the correspondence information includes
a first set including a plurality of characteristic values indicating ejection characteristics of an ink jet head used in accordance with the first usage condition and first output condition information indicating an output condition corresponding to the first usage condition, and
a second set including a plurality of characteristic values indicating ejection characteristics of an ink jet head used in accordance with the second usage condition and second output condition information indicating an output condition corresponding to the second usage condition, and
the determination section
calculates a first degree of similarity between the ejection characteristics indicated by the characteristic information acquired by the acquisition section and the ejection characteristics indicated by the plurality of characteristic values included in the first set, based on the plurality of characteristic values included in the first set and the plurality of characteristic values indicated by the characteristic information acquired by the acquisition section,
calculates a second degree of similarity between the ejection characteristics indicated by the characteristic information acquired by the acquisition section and the ejection characteristics indicated by the plurality of characteristic values included in the second set, based on the plurality of characteristic values included in the second set and the plurality of characteristic values indicated by the characteristic information acquired by the acquisition section, and
determines, based on a comparison result between the first degree of similarity and the second degree of similarity, either the first output condition information or the second output condition information as the output condition information indicating the output condition corresponding to the usage condition of the specific user.

7. The system according to claim 1, wherein
the determination section
when the usage condition information acquired by the acquisition section and the usage condition information defined in the correspondence information coincide, determines, as the output condition information indicating the output condition corresponding to the usage condition of the specific user, the output condition information defined in the correspondence information, and
when the usage condition information acquired by the acquisition section and the usage condition information defined in the correspondence information do not coincide, determines the output condition information indicating the output condition corresponding to the usage condition of the specific user, based on the degree of similarity between the ejection characteristics indicated by the characteristic information acquired by the acquisition section and the ejection characteristics indicated by characteristic information defined in the correspondence information.

8. A server for use in a system used to eject ink using an ink jet head, the server comprising:
a storage section that stores correspondence information that defines combinations of characteristic information indicating ejection characteristics of an ink jet head used in accordance with one or more usage conditions, usage condition information indicating the one or more usage conditions, and output condition information indicating an output condition corresponding to the one or more usage conditions;
an acquisition section that acquires characteristic information indicating ejection characteristics of an ink jet head used in accordance with a usage condition of a specific user and usage condition information indicating the usage condition of the specific user; and
a determination section that determines, with reference to the correspondence information, output condition information indicating an output condition corresponding to the usage condition of the specific user, based on a degree of similarity between the ejection characteristics indicated by the characteristic information acquired by the acquisition section and the ejection characteristics indicated by the characteristic information defined in the correspondence information.
